(19) United States
(12) Patent Application Publication
(10) Pub. No.: US 2025/0199661 A1
(43) Pub. Date: Jun. 19, 2025

(54) INFORMATION DISPLAY METHOD, MEDIUM, AND ELECTRONIC DEVICE

(71) Applicant: Douyin Vision Co., Ltd., Shijingshan District, Beijing (CN)

(72) Inventors: Mengji Zhou, Beijing (CN); Jiahao Chen, Beijing (CN); Linman LI, Beijing (CN)

(21) Appl. No.: 18/981,094

(22) Filed: Dec. 13, 2024

(30) Foreign Application Priority Data
Dec. 14, 2023 (CN) 202311727603.7

(51) Int. Cl. G06F 3/0484; G06T 11/00

(52) U.S. Cl. CPC G06F 3/0484; G06T 11/00

(57) ABSTRACT

An information display method, a medium, and an electronic device are provided. The method includes: displaying a first information display interface of a sharing platform, in which the first information display interface includes a first display region and a second display region, the first display region is configured to display a function component that provides a function of drawing an image work, and the second display region is configured to display image works drawn by different users based on the sharing platform; and displaying a second information display interface of the sharing platform in response to an interaction operation for a target object in a target region, in which the target region is the first display region or the second display region, and the target object is the function component or an image work displayed in the second display region.

### CROSS-REFERENCE TO RELATED APPLICATION

This application claims the priority of Chinese Patent Application No. 202311727603.7, filed on Dec. 14, 2023, the disclosure of which is incorporated by reference herein in its entirety as part of the present application.

### TECHNICAL FIELD

The present disclosure relates to the field of Internet technologies, and specifically, to an information display method and apparatus, a medium, and an electronic device.

### BACKGROUND

Existing artificial intelligence (AI) painting technologies are generally used to generate a corresponding image based on a text and a selected style that are provided by a user. However, an operation of a painting tool based on the AI painting technologies is complex and difficult to learn, more importantly, the function is relatively single, and exchange and interaction between users are relatively limited.

### SUMMARY

The Summary is to introduce the concepts in a simplified form, which will be described in detail later in the Detailed Description. The Summary is not intended to identify the key features or essential features of the claimed technical solutions, nor is it intended to limit the scope of the claimed technical solutions.

According to a first aspect, the present disclosure provides an information display method, which comprises:
displaying a first information display interface of a sharing platform, in which the first information display interface comprises a first display region and a second display region, the first display region is configured to display a function component that provides a function of drawing an image work, and the second display region is configured to display image works drawn by different users based on the sharing platform; and
displaying a second information display interface of the sharing platform in response to an interaction operation for a target object in a target region, in which the target region is the first display region or the second display region, and the target object is the function component or an image work displayed in the second display region.

According to a second aspect, the present disclosure provides an information display apparatus, which comprises:
a first display module, configured to display a first information display interface of a sharing platform, in which the first information display interface comprises a first display region and a second display region, the first display region is configured to display a function component that provides a function of drawing an image work, and the second display region is configured to display image works drawn by different users based on the sharing platform; and
a second display module, configured to display a second information display interface of the sharing platform in response to an interaction operation for a target object in a target region, in which the target region is the first display region or the second display region, and the target object is the function component or an image work displayed in the second display region.

According to a third aspect, the present disclosure provides a computer-readable medium having a computer program stored thereon, when the program is executed by a processing apparatus, steps of the method according to the first aspect are implemented.

According to a fourth aspect, the present disclosure provides an electronic device, which comprises:
a storage apparatus having a computer program stored thereon; and
a processing apparatus configured to execute the computer program in the storage apparatus to implement steps of the method according to the first aspect.

Other features and advantages of the present disclosure will be described in detail in the following specific implementations.

### BRIEF DESCRIPTION OF DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and components and elements are not necessarily drawn to scale. In the drawings:

FIG. 1 is a flowchart of an information display method according to an exemplary embodiment of the present disclosure;

FIG. 2 is a schematic diagram of a first information display interface according to an exemplary embodiment of the present disclosure;

FIG. 3 is another schematic diagram of a first information display interface according to an exemplary embodiment of the present disclosure;

FIG. 4 is a schematic diagram of a first intermediate information display interface according to an exemplary embodiment of the present disclosure;

FIG. 5 is another schematic diagram of a first information display interface according to an exemplary embodiment of the present disclosure;

FIG. 6 is a schematic diagram of a second intermediate information display interface according to an exemplary embodiment of the present disclosure;

FIG. 7 is a schematic diagram of an intermediate information display interface according to an exemplary embodiment of the present disclosure;

FIG. 8 is another schematic diagram of an intermediate information display interface according to an exemplary embodiment of the present disclosure;

FIG. 9 is another schematic diagram of a second information display interface according to an exemplary embodiment of the present disclosure;

FIG. 10 is a block diagram of an information display apparatus according to an exemplary embodiment of the present disclosure; and

FIG. 11 is a structural schematic diagram of an electronic device according to an exemplary embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the implementations of the present disclosure are used for illustrative purposes only, and are not used to limit the scope of these messages or information.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select “agree” or “disagree” to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

In addition, it can be understood that the data involved in this technical solution (including but not limited to the data itself, the acquisition or use of data) should comply with the requirements of corresponding laws and regulations and related regulations.

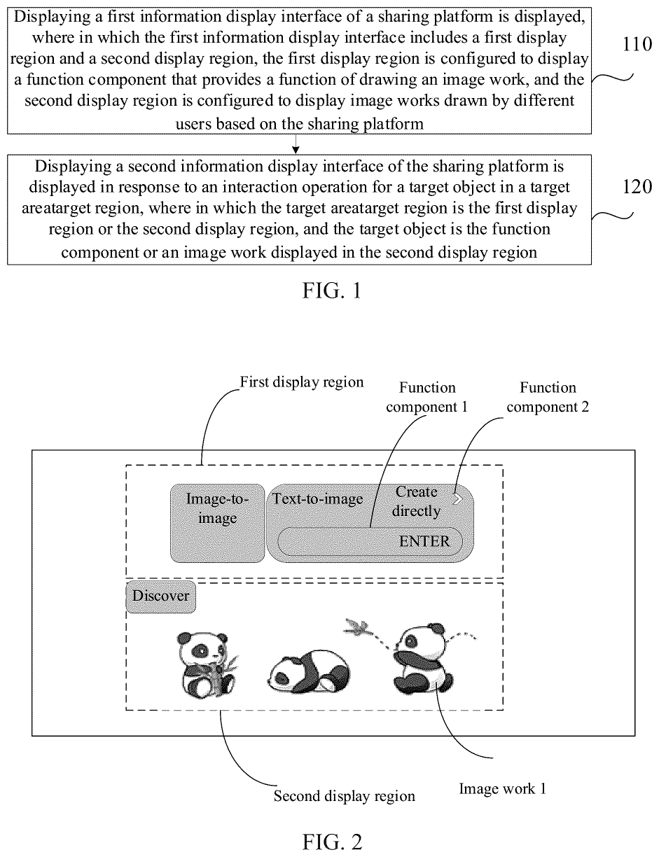

FIG. 1 is a flowchart of an information display method according to an exemplary embodiment of the present disclosure. The information display method may be performed by an electronic device, and specifically may be performed by an information display apparatus implemented by software and/or hardware. Referring to FIG. 1, the information display method may include the following steps.

Step 110: displaying a first information display interface of a sharing platform, in which the first information display interface includes a first display region and a second display region, the first display region is configured to display a function component that provides a function of drawing an image work, and the second display region is configured to display image works drawn by different users based on the sharing platform.

Step 120: displaying a second information display interface of the sharing platform in response to an interaction operation for a target object in a target region, in which the target region is the first display region or the second display region, and the target object is the function component or an image work displayed in the second display region.

It should be noted that the sharing platform is a tool that supports intelligent drawing and information exchange between users. The intelligent drawing here includes two methods: generating an image based on a text and generating a new image based on a text and an image. The method of generating an image based on a text is hereinafter referred to as text-to-image, and the method of generating a new image based on a text and an image is hereinafter referred to as image-to-image. As an example, the information exchange between users includes information exchange such as posting image works to the sharing platform and collecting image works posted by other users to the sharing platform.

It may be understood that the first display region is configured to support a user to draw an image work, and the second display region is configured to display an image work drawn by the user based on the sharing platform.

It should be noted that the interaction operation in this embodiment may be used to implement the drawing of the image work by the user, or to implement interactive exchange between the users using the image work as a medium.

FIG. 2 is a schematic diagram of a first information display interface according to an exemplary embodiment of the present disclosure. As shown in FIG. 2, the first information display interface includes a first display region and a second display region, the first display region is configured to display a function component that provides a function of drawing an image work (for example, the function component 1 and the function component 2 shown in FIG. 2), and the second display region is configured to display image works drawn by different users based on the sharing platform (for example, the image work 1 shown in FIG. 2).

As an example, the target region may be the first display region, and the corresponding target object may be a function component in the first display region. In other words, the electronic device may display the second information display interface of the sharing platform in response to an interaction operation for the function component in the first display region.

As an example, the target region may be the second display region, and the corresponding target object may be an image work displayed in the second display region. In other words, the electronic device may display the second information display interface of the sharing platform in response to an interaction operation for the image work displayed in the second display region.

In the above manner, the first information display interface of the sharing platform includes the first display region and the second display region, the first display region is configured to display the function component that provides the function of drawing the image work, the second display region is configured to display the image work(s) drawn by different users based on the sharing platform, and the second information display interface of the sharing platform is displayed in response to the interaction operation for the target object in the first display region or the second display region, so that the requirement of the user for creating the image work can be met, and the interactive exchange of the image works between the different users based on the sharing platform is also supported, thereby improving the functionality of the sharing platform. In addition, compared with sharing image works to a third party, sharing the image works in the sharing platform is more convenient for interactive exchange between users in the same vertical category.

In some embodiments, the first information display interface may further include a third display region, the third display region is configured to display a second interaction control related to a user, and the second interaction control includes a collection control for entering an interface that displays an image work collected by the user and a user work control for entering an interface that displays an image work created by the user.

It should be noted that the electronic device may enter an interface corresponding to the second interaction control in response to an interaction operation for the second interaction control, that is, display the interface corresponding to the second interaction control. As an example, the interaction operation may be a click operation, a double-click operation, and the like.

The second interaction control may further include a user control for entering an interface corresponding to a user home page. Further, the electronic device may enter the interface corresponding to the user control in response to an interaction operation for the user control, that is, display the user home page corresponding to the user control. The user home page may display a user avatar, an image work collected by the user, an image work created by the user, and the like. For example, the interaction operation may be a click operation, a double-click operation, and the like.

The display region corresponding to the second interaction control displays corresponding quantity prompt information.

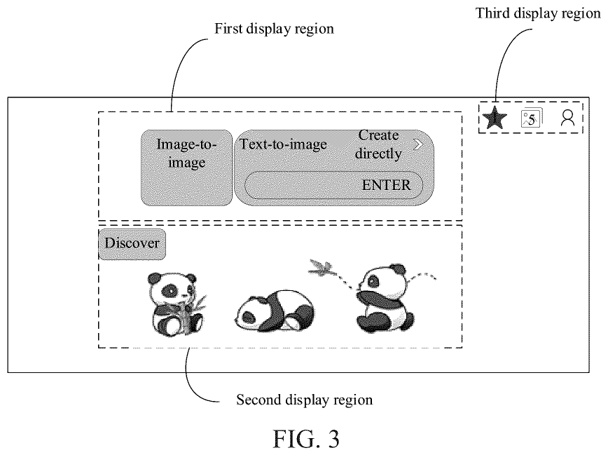

FIG. 3 is another schematic diagram of a first information display interface according to an exemplary embodiment of the present disclosure. As shown in FIG. 3, the third display region displays a collection control, a user work control, and a user home page control from left to right, and the collection control and the user work control respectively display the corresponding quantity to prompt the user, for prompting the user of the quantity of the image work(s) collected by the user and the quantity of the image work(s) created by the user.

In the above manner, a personal center corresponding to the user is provided, so that the user can manage the image work(s) collected by the user and the image work(s) created by the user through the sharing platform, thereby facilitating improving the user's stickiness to the sharing platform.

Among users targeted by the sharing platform, according to the familiarity of the users with the sharing platform, the users may be divided into two types of users: one type is users with a familiarity less than a preset familiarity, and the other type is users with a familiarity greater than or equal to the preset familiarity. The former users may be understood as new users of the sharing platform. The new users may only focus on trying the effect based on the text-to-image and image-to-image, and do not care about finer-grained creation, that is, do not care about setting of other attributes with finer granularity that can affect the image work other than the text and the image. The latter users may be understood as old users of the sharing platform, who not only focus on the text and the image, but also care about the impact of setting of other attributes with finer granularity on the generated image work. Therefore, for different types of users, the sharing platform provides two functions of creating image works. The following provides an exemplary description of the functions of the sharing platform to create image works for different types of users in the text-to-image and image-to-image modes.

First, the text-to-image mode is described. The text-to-image mode is a mode of generating a corresponding image work based on a text and an image generation model. In this mode, for users with a familiarity less than the preset familiarity, the target region includes the first display region, the target object includes the function component, the function component includes a first function component, the first function component is configured to implement generation of a corresponding image work based on a text and an image generation model. In this case, the step of displaying the second information display interface of the sharing platform in response to an interaction operation for a target object in a target region may include: determining first guidance information in response to an input operation for a first information input control of the first function component in the first display region, in which the first guidance information includes text information corresponding to the input operation; and displaying the second information display interface of the sharing platform in response to a first generation instruction, in which the second information display interface is configured to display an image work correspondingly generated based on the first guidance information and a first image generation model.

The first image generation model may be an image generation model that is set by default by the sharing platform. The text information is used as the input to the first image generation model, and the first image generation model processes the text information and outputs the corresponding image work, and the image work can represent semantic information expressed by the text information.

As an example, the image work correspondingly generated based on the text information and the first image generation model may be displayed in a floating layer and superimposed on the first information display interface, to form the second information display interface. In an implementation, a close control is displayed on the second information display interface, and the electronic device may close the floating layer, that is, close the display of the image work in response to a close instruction for the close control, to quickly switch to the first information display interface.

With continued reference to the example shown in FIG. 2, the “Function component 1” shown in FIG. 2 is an example of the first information input control, and the user may implement input of text information through an input operation for the first information input control; and the “ENTER” control shown in FIG. 2 may be used by the user to trigger generation of the first generation instruction. For example, the user may click the “ENTER” control to trigger the first generation instruction, and then the second information display interface of the sharing platform is displayed, the second information display interface is configured to display an image work correspondingly generated based on the text information input by the user and the first image generation model.

In the above manner, in the first information display interface, the interaction page is simple, and the user only needs to input the text information and trigger the first generation instruction, so that the corresponding image work can be quickly generated, thereby reducing the operation difficulty of the users with a familiarity less than the preset familiarity.

For users with a familiarity greater than or equal to the preset familiarity, the step of displaying the second information display interface of the sharing platform in response to an interaction operation for a target object in a target region may include: displaying a first intermediate information display interface of the sharing platform in response to a second generation instruction for a creation control of the first function component in the first display region, in which the first intermediate information display interface includes a configuration item of a plurality of image attributes and a second information input control; determining second guidance information in response to an input operation for the second information input control and a configuration operation for the configuration item, in which the second guidance information includes text information corresponding to the input operation and attribute configuration information corresponding to the configuration operation; and displaying the second information display interface of the sharing platform in response to a third generation instruction, in which the second information display interface is configured to display an image work correspondingly generated based on the second guidance information and a second image generation model.

The image attributes may include an image quantity attribute, an image style attribute, a resolution of an image work, a text weight attribute, a random attribute, and the like. The image quantity attribute is used to indicate the number of image work(s) correspondingly generated based on the second guidance information and the second image generation model. The image style attribute is used to indicate a style of the image work, for example, an animation style, and the second image generation models for different image style attributes are different. The resolution of the image work is used to indicate a size of the image work. The text weight attribute is used to indicate an influence degree of the text information in a process of generating the image work based on the second image generation model. The greater the influence degree of the text information is, the closer the semantic information of the generated image work is to the description of the text information. The random attribute is used to indicate a value of a random seed of the generated image work. When the value is a fixed value, the generated image work corresponds to the value; and when the value is a random value, the generated image work is random.

The second image generation model may be an image generation model configured by the user based on the configuration operation, and it should be noted that when the user does not configure the image generation model, the second image generation model may be an image generation model that is set by default by the sharing platform. The text information and the attribute configuration information are used as the input to the second image generation model, and the second image generation model processes the text information and the attribute configuration information and outputs the corresponding image work.

As an example, the image work correspondingly generated based on the text information, the attribute configuration information corresponding to the configuration operation, and the second image generation model may be displayed in a floating layer and superimposed on the first intermediate information display interface, to form the second information display interface. In an implementation, a close control is displayed on the second information display interface, and the electronic device may close the floating layer, that is, close the display of the image work in response to a close instruction for the close control, to quickly switch to the first intermediate information display interface.

With continued reference to the example shown in FIG. 2, the “Function component 2” shown in FIG. 2 is an example of a creation control, and the user may trigger the second generation instruction based on the creation control, to display the first intermediate information display interface.

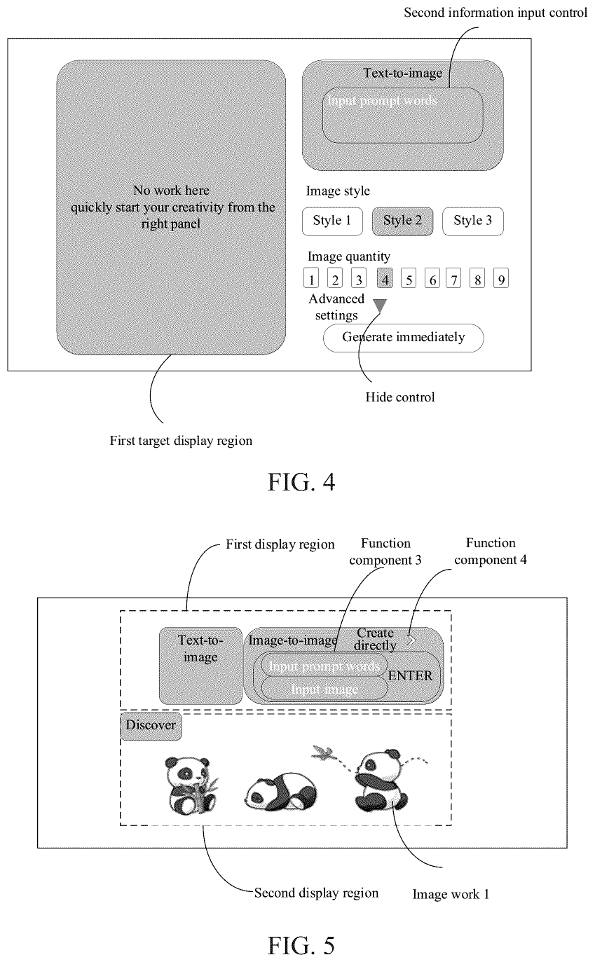

As another example, FIG. 4 is a schematic diagram of a first intermediate information display interface according to an exemplary embodiment of the present disclosure. Text information may be input based on the “Second information input control” shown in FIG. 4. “Image style” shown in FIG. 4 corresponds to the above image style attribute, and “Style 1”, “Style 2”, and “Style 3” are used as candidate attribute values of the image style attribute. The user determines attribute configuration information of the image style attribute based on a selected style. “Image quantity” shown in FIG. 4 corresponds to the above image quantity attribute, and the numerals “1”, “2”, . . . , and “9” are used as candidate attribute values of the image quantity attribute. The user determines attribute configuration information of the image quantity attribute based on a selected numeral. The configuration item of other image attributes may be hidden under the advanced settings, and the user may implement display or hiding of the configuration item of the other image attributes based on interaction with the “Hide control” shown in FIG. 4, and then determine attribute configuration information of the corresponding configuration item when the other image attributes are displayed.

In FIG. 4, the first target display region may be used as a display region of the image work, and the user may trigger the third generation instruction based on the “generate immediately” control shown in FIG. 4, to display the image work correspondingly generated based on the second guidance information and the second image generation model in the first target display region. In other words, the second information display interface may include the image work correspondingly generated based on the second guidance information and the second image generation model and the configuration item of the image attributes and the second information input control displayed in the first intermediate information display interface, without the need of the user to switch to an interface for changing the configuration item of the image attributes and the second information input control based on an operation for the electronic device. This facilitates the user to quickly update the image work based on the change to the configuration item of the image attributes and the second information input control.

In the above manner, on the second information display interface, a configuration interface for entering more configuration items that affect generation of the image work is provided, and finer-grained attribute configuration may be implemented based on the first intermediate information display interface, so that a richer image work is created, thereby improving user experience of users with a familiarity greater than the preset familiarity.

Next, the image-to-image mode is described. The image-to-image mode is a mode of generating a corresponding image work based on a text, an image, and an image generation model. In this mode, for users with a familiarity less than the preset familiarity, the target region includes the first display region, the target object includes the function component, the function component includes a second function component, the second function component is configured to implement generation of a corresponding image work based on the text, the image, and the image generation model. In this case, the step of displaying the second information display interface of the sharing platform in response to an interaction operation for a target object in a target region may include: determining third guidance information in response to an input operation for a third information input control of the second function component in the first display region, in which the third guidance information includes text information and image information corresponding to the input operation; and displaying the second information display interface of the sharing platform in response to a fourth generation instruction, in which the second information display interface is configured to display an image work correspondingly generated based on the third guidance information and a third image generation model.

The third information input control includes two input sub-controls, one is used for supporting input of the text information, and the other one is used for supporting input of the image information.

Similar to the first image generation model, the third image generation model may be an image generation model that is set by default by the sharing platform. The text information and the image information are used as input to the third image generation model, and the third image generation model processes the text information and the image information and outputs the corresponding image work, and the image work can represent information expressed by the text information and the image information.

As an example, the image work correspondingly generated based on the text information, the image information, and the third image generation model may be displayed in a floating layer and superimposed on the first information display interface, to form the second information display interface. In an implementation, a close control is displayed on the second information display interface, and the electronic device may close the floating layer, that is, close the display of the image work in response to a close instruction for the close control, to quickly switch to the first information display interface.

FIG. 5 is another schematic diagram of a first information display interface according to an exemplary embodiment of the present disclosure. The “Function component 3” shown in FIG. 5 is an example of the third information input control, and the third information input control includes two input sub-controls. The user inputs the text information based on one input sub-control, for example, the input sub-control corresponding to the input sub-control “Input prompt words” shown in FIG. 5; and the user inputs the image information based on the other input sub-control, for example, the input sub-control corresponding to the input sub-control “Input image” shown in FIG. 5. The “ENTER” control shown in FIG. 5 may be used by the user to trigger generation of the fourth generation instruction. For example, the user may click the “ENTER” control to trigger the fourth generation instruction, and then the second information display interface of the sharing platform is displayed, the second information display interface is configured to display an image work correspondingly generated based on the text information and the image information input by the user, and the third image generation model.

In the above manner, in the first information display interface, the user only needs to input the text information and the image information, and trigger the fourth generation instruction, so that the corresponding image work can be quickly generated, thereby reducing the operation difficulty of the users with a familiarity less than the preset familiarity.

For users with a familiarity greater than or equal to the preset familiarity, the step of displaying the second information display interface of the sharing platform in response to an interaction operation for a target object in a target region may include: displaying a second intermediate information display interface of the sharing platform in response to a fifth generation instruction for a creation control of the second function component in the second display region, in which the second intermediate information display interface includes a configuration item of a plurality of image attributes and a fourth information input control; determining fourth guidance information in response to an input operation for the fourth information input control and a configuration operation for the configuration item, in which the fourth guidance information includes text information and image information corresponding to the input operation, and attribute configuration information corresponding to the configuration operation; and displaying the second information display interface of the sharing platform in response to a sixth generation instruction, in which the second information display interface is configured to display an image work correspondingly generated based on the fourth guidance information and a fourth image generation model.

Similar to the second image generation model, the fourth image generation model may be an image generation model configured by the user based on the configuration operation, and it should be noted that when the user does not configure the image generation model, the fourth image generation model may be an image generation model that is set by default by the sharing platform. The text information, the image information, and the attribute configuration information are used as the input to the fourth image generation model, and the fourth image generation model processes the text information, the image information, and the attribute configuration information and outputs the corresponding image work. It should be noted that for the image attributes in this embodiment, reference may be made to the foregoing related embodiments, and details are not described in this embodiment again.

As an example, the image work correspondingly generated based on the text information, the image information, and the fourth image generation model may be displayed in a floating layer and superimposed on the first information display interface, to form the second information display interface. In an implementation, a close control is displayed on the second information display interface, and the electronic device may close the floating layer, that is, close the display of the image work in response to a close instruction for the close control, to quickly switch to the first information display interface.

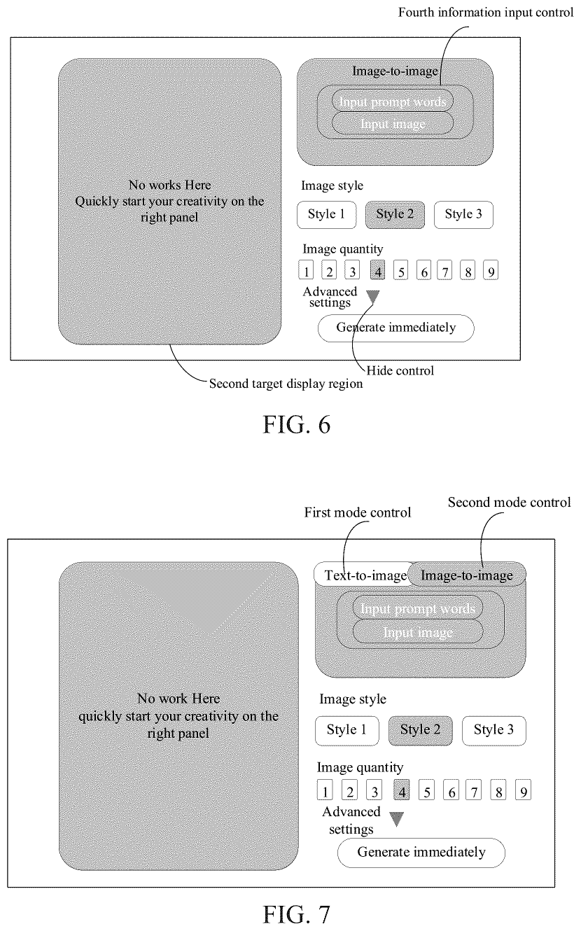

As another example, FIG. 6 is a schematic diagram of a second intermediate information display interface according to an exemplary embodiment of the present disclosure. The text information and image information may be input based on the “Fourth information input control” shown in FIG. 6. “Image style” shown in FIG. 6 corresponds to the above image style attribute, and “Style 1”, “Style 2”, and “Style 3” are used as candidate attribute values of the image style attribute. The user determines attribute configuration information of the image style attribute based on a selected style. “Image quantity” shown in FIG. 6 corresponds to the above image quantity attribute, and the numerals “1”, “2”, . . . , and “9” are used as candidate attribute values of the image quantity attribute. The user determines attribute configuration information of the image quantity attribute based on a selected numeral. Configuration items of other image attributes may be hidden under advanced settings, and the user may implement display or hiding of the configuration items of the other image attributes based on interaction with the “Hide control” shown in FIG. 6, and then determine attribute configuration information of the corresponding configuration items when the other image attributes are displayed.

In FIG. 6, the second target display region may be used as the display region of the image work, and the user may trigger the fourth generation instruction based on the “Generate immediately” control shown in FIG. 6, to display the image work correspondingly generated based on the fourth guidance information and the fourth image generation model in the second target display region. In other words, the second information display interface may include the image work correspondingly generated based on the fourth guidance information and the fourth image generation model, the configuration item of the image attributes, and the fourth information input control displayed in the second intermediate information display interface, without the need of the user to switch to an interface for changing the configuration item of the image attributes and the fourth information input control based on an operation for the electronic device. This facilitates the user to quickly update the image work based on the change to the configuration item of the image attributes and the fourth information input control.

In the above manner, on the second information display interface, a configuration interface for entering more configuration items that affect generation of the image work is provided, and generation of the corresponding image work is implemented based on the second intermediate information display interface, thereby improving user experience of users with a familiarity greater than the preset familiarity.

In some embodiments, the intermediate information display interface may display a first mode control and a second mode control, and the electronic device may display a corresponding intermediate information display interface in response to a mode switching instruction for a target mode control. The intermediate information display interface here may be the first intermediate information display interface or the second intermediate information display interface, the first mode control corresponds to the first intermediate information display interface, and the second mode control corresponds to the second intermediate information display interface.

FIG. 7 is a schematic diagram of an intermediate information display interface according to an exemplary embodiment of the present disclosure. The intermediate information display interface may display the first mode control and the second mode control, and the interface is switched to the corresponding intermediate information display interface by clicking the target mode control. For example, the first intermediate information display interface may be displayed by clicking the first mode control, and the second intermediate information display interface may be displayed by clicking the second mode control.

In the above manner, the first intermediate information display interface and the second intermediate information display interface can be quickly switched, without returning to the first information display interface, the switching between the text-to-image mode and the image-to-image mode can be implemented, and the user can quickly enter a creation interface that supports finer-grained image works.

In some embodiments, the intermediate information display interface may further display an image work generated at a historical moment. For the explanation and description of the intermediate information display interface, reference may be made to the foregoing related embodiments, and details are not described in this embodiment again.

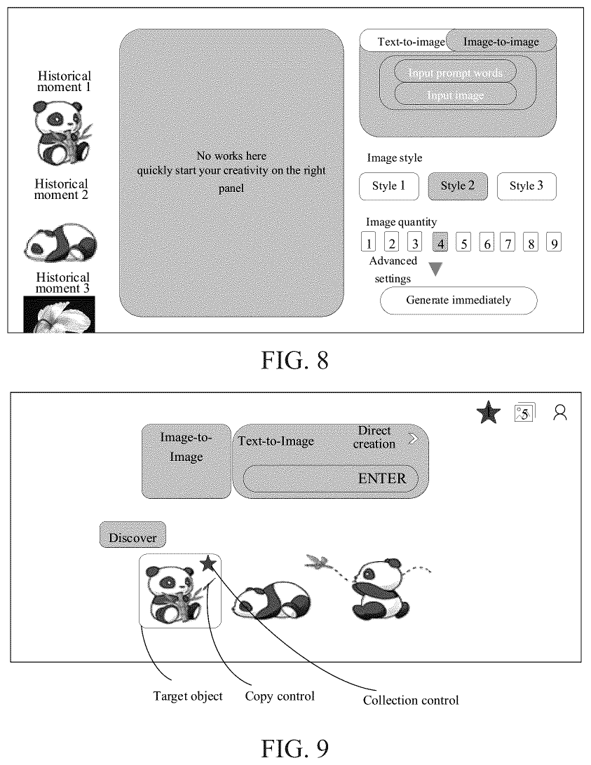

FIG. 8 is another schematic diagram of an intermediate information display interface according to an exemplary embodiment of the present disclosure. In FIG. 8, the intermediate information display interface respectively displays image works produced at a historical moment 1, a historical moment 2, and a historical moment 3.

In the above manner, the image works created by the user at the historical moment are provided, so that the user can view the image works conveniently.

In some embodiments, the target region includes the second display region, the target object includes an image work displayed in the second display region, and the displaying the second information display interface of the sharing platform in response to an interaction operation for a target object in a target region may include: displaying the second information display interface of the sharing platform in response to a selection operation for an image work displayed in the second display region, in which the second information display interface displays a first interaction control for the image work, and the first interaction control includes a collection control for a user to collect an image work and/or a copy control for a user to copy an image work.

The selection operation may be that a cursor of the electronic device stays in a region where the image work is displayed.

When the user interacts with the collection control through the electronic device, the corresponding image work can be collected, so that when the user clicks the collection control in the third display region, the image work can be quickly viewed. As an example, the interaction here may be a click or a double-click, and the like.

When the user interacts with the copy control through the electronic device, the user can quickly enter a corresponding intermediate information display interface and copy a parameter (for example, text information) for creating the corresponding image work to a corresponding information input control (for example, the fourth information input control) or configuration item. For the intermediate information display interface, the information input control, and the configuration item, reference may be made to the foregoing related embodiments, and details are not described in this embodiment again.

FIG. 9 is another schematic diagram of a second information display interface according to an exemplary embodiment of the present disclosure. In FIG. 9, the user copies the target object through the copy control, and collects the target object through the collection control.

In the above manner, the interactive exchange of the image works between the different users based on the sharing platform is further improved, thereby improving the functionality of the sharing platform.

In some embodiments, corresponding hotspot information may be displayed at an information input control that requires input of the text information and the image information, the hotspot information is text information or an image with a heat greater than a preset heat threshold; in this case, the electronic device may implement an input operation for the corresponding information input control in response to a selection operation of the user for the hotspot information. The information input control here is, for example, the foregoing first information input control, the second information input control, the third information input control, and the fourth information input control.

In the above manner, the quick input of the hotspot information is implemented, so that the user can quickly create the image work with a higher current heat.

In some embodiments, the electronic device may perform statistics and analysis on the image work created by a user to obtain a preference image work of the user; in this case, when the user uses the sharing platform, image works with a similarity to the preference image work of the user greater than a preset similarity threshold are preferentially displayed in the second display region.

In the above manner, the personalized display of the second display region in the sharing platform is implemented, thereby further improving user experience.

In some embodiments, the sharing platform may be provided with priorities of image works displayed in the second display region. For example, the priority of preference image work may be set to be greater than the priority of the image work with the highest heat, so that the image work with a similarity to the preference image work of the user greater than the preset similarity threshold are preferentially displayed in the second display region.

In some embodiments, when the corresponding image work is generated based on the text, the image, and the image generation model, the determining the third guidance information in response to an input operation for a third information input control of the second function component in the first display region may include: determining the third guidance information in response to a photographing operation for the third information input control of the second function component in the first display region, in which the third guidance information includes image information.

For example, the photographing operation is implemented based on an input sub-control included in the third information input control and configured to input the image information. Real-time photographing is implemented based on the input sub-control, and then image information obtained based on the real-time photographing is used as the third guidance information.

In the above manner, real-time photographing is supported to obtain the image information in the third guidance information, thereby simplifying the operation difficulty of creating the image work.

In some embodiments, the foregoing first image generation model, second image generation model, third image generation model, and fourth image generation model may be diffusion models. For the diffusion models, reference may be made to related technologies, and details are not described in this embodiment again.

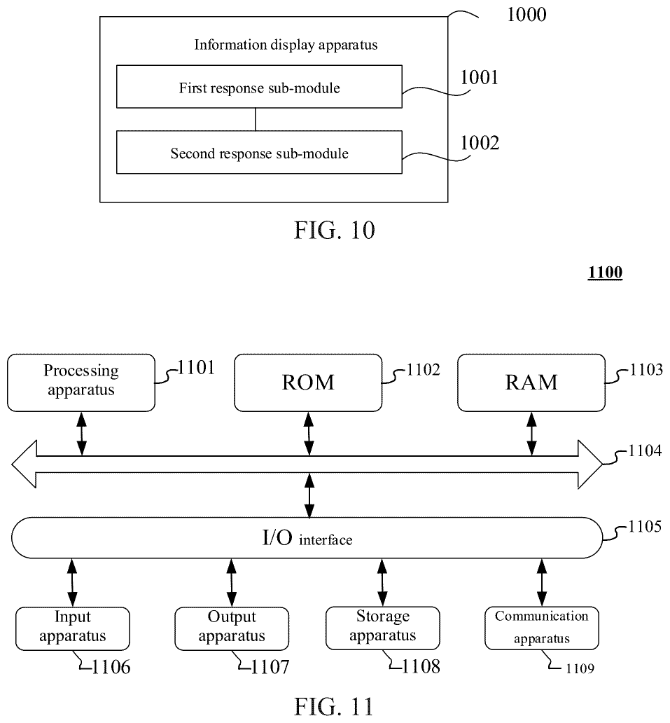

Based on the same concept, the embodiments of the present disclosure provide an information display apparatus. FIG. 10 is a block diagram of an information display apparatus according to an exemplary embodiment of the present disclosure. Referring to FIG. 10, the information display apparatus 1000 includes:
a first display module 1001, configured to display a first information display interface of a sharing platform, in which the first information display interface includes a first display region and a second display region, the first display region is configured to display a function component that provides a function of drawing an image work, and the second display region is configured to display image works drawn by different users based on the sharing platform; and
a second display module 1002, configured to display a second information display interface of the sharing platform in response to an interaction operation for a target object in a target region, in which the target region is the first display region or the second display region, and the target object is the function component or an image work displayed in the second display region.

In some embodiments, the target region includes the first display region, the target object includes the function component, the function component includes a first function component, the first function component is configured to implement generation of a corresponding image work based on a text and an image generation model, and the second display module 1002 includes:
a first response sub-module, configured to determine first guidance information in response to an input operation for a first information input control of the first function component in the first display region, in which the first guidance information includes text information corresponding to the input operation; and
a second response sub-module, configured to display the second information display interface of the sharing platform in response to a first generation instruction, in which the second information display interface is configured to display an image work correspondingly generated based on the first guidance information and a first image generation model.

In some embodiments, the second display module 1002 includes:
a third response sub-module, configured to display a first intermediate information display interface of the sharing platform in response to a second generation instruction for a creation control of the first function component in the first display region, in which the first intermediate information display interface includes a configuration item of a plurality of image attributes and a second information input control;
a fourth response sub-module, configured to determine second guidance information in response to an input operation for the second information input control and a configuration operation for the configuration item, in which the second guidance information includes text information corresponding to the input operation and attribute configuration information corresponding to the configuration operation; and
a fifth response sub-module, configured to display the second information display interface of the sharing platform in response to a third generation instruction, in which the second information display interface is configured to display an image work correspondingly generated based on the second guidance information and a second image generation model.

In some embodiments, the function component includes a second function component, the second function component is configured to implement generation of a corresponding image work based on a text, an image, and an image generation model, and the second display module 1002 includes:
a sixth response sub-module, configured to determine third guidance information in response to an input operation for a third information input control of the second function component in the first display region, in which the third guidance information includes text information and image information corresponding to the input operation; and
a seventh response sub-module, configured to display the second information display interface of the sharing platform in response to a fourth generation instruction, in which the second information display interface is configured to display an image work correspondingly generated based on the third guidance information and a third image generation model.

In some embodiments, the second display module 1002 includes:
an eighth response sub-module, configured to display a second intermediate information display interface of the sharing platform in response to a fifth generation instruction for a creation control of the second function component in the second display region, in which the second intermediate information display interface includes a configuration item of a plurality of image attributes and a fourth information input control;
a ninth response sub-module, configured to determine fourth guidance information in response to an input operation for the fourth information input control and a configuration operation for the configuration item, in which the fourth guidance information includes text information and image information corresponding to the input operation, and attribute configuration information corresponding to the configuration operation; and
a tenth response sub-module, configured to display the second information display interface of the sharing platform in response to a sixth generation instruction, in which the second information display interface is configured to display an image work correspondingly generated based on the fourth guidance information and a fourth image generation model.

In some embodiments, the target region includes the second display region, the target object includes an image work displayed in the second display region, and the second display module 1002 includes:
an eleventh response sub-module, configured to display the second information display interface of the sharing platform in response to a selection operation for an image work displayed in the second display region, in which the second information display interface displays a first interaction control for the image work, and the first interaction control includes a collection control for a user to collect an image work and/or a copy control for a user to copy an image work.

In some embodiments, the first information display interface further includes a third display region, the third display region is configured to display a second interaction control related to a user, and the second interaction control includes a collection control for entering an interface that displays an image work collected by the user and a user work control for entering an interface that displays an image work created by the user.

For an implementation of each module in the information display apparatus 1000, reference may be made to the foregoing related embodiments, and details are not described in this embodiment again.

Based on the same concept, the embodiments of the present disclosure further provide a computer-readable medium having a computer program stored thereon, when the computer program is executed by a processing apparatus, steps of the information display method described above are implemented.

Based on the same concept, the embodiments of the present disclosure further provide an electronic device, which includes:
a storage apparatus having a computer program stored thereon; and
a processing apparatus configured to execute the computer program in the storage apparatus, to implement steps of the information display method described above.

Referring to FIG. 11, which illustrates a structural schematic diagram of an electronic device 1100 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The electronic device illustrated in FIG. 11 is merely an example, and should not pose any limitation to the functions and the range of use of the embodiments of the present disclosure.

As illustrated in FIG. 11, the electronic device 1100 may include a processing apparatus 1101 (e.g., a central processing unit, a graphics processing unit, etc.), which can perform various suitable actions and processing according to a program stored in a read-only memory (ROM) 1102 or a program loaded from a storage apparatus 1108 into a random-access memory (RAM) 1103. The RAM 1103 further stores various programs and data required for operations of the electronic device 1100. The processing apparatus 1101, the ROM 1102, and the RAM 1103 are interconnected by means of a bus 1104. An input/output (I/O) interface 1105 is also connected to the bus 1104.

Usually, the following apparatus may be connected to the I/O interface 1105: an input apparatus 1106 including, for example, a touch screen, a touch pad, a keyboard, a mouse, a camera, a microphone, an accelerometer, a gyroscope, or the like; an output apparatus 1107 including, for example, a liquid crystal display (LCD), a loudspeaker, a vibrator, or the like; a storage apparatus 1108 including, for example, a magnetic tape, a hard disk, or the like; and a communication apparatus 1109. The communication apparatus 1109 may allow the electronic device 1100 to be in wireless or wired communication with other devices to exchange data. While FIG. 11 illustrates the electronic device 1100 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1109 and installed, or may be installed from the storage apparatus 1108, or may be installed from the ROM 1102. When the computer program is executed by the processing apparatus 1101, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a first information display interface of a sharing platform, in which the first information display interface includes a first display region and a second display region, the first display region is configured to display a function component that provides a function of drawing an image work, and the second display region is configured to display image works drawn by different users based on the sharing platform; and display a second information display interface of the sharing platform in response to an interaction operation for a target object in a target region, in which the target region is the first display region or the second display region, and the target object is the function component or an image work displayed in the second display region.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. Among them, the name of the module does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An information display method, comprising:
displaying a first information display interface of a sharing platform, wherein the first information display interface comprises a first display region and a second display region, the first display region is configured to display a function component that provides a function of drawing an image work, and the second display region is configured to display image works drawn by different users based on the sharing platform; and
displaying a second information display interface of the sharing platform in response to an interaction operation for a target object in a target region, wherein the target region is the first display region or the second display region, and the target object is the function component or an image work displayed in the second display region.

2. The method according to claim 1, wherein the target region comprises the first display region, the target object comprises the function component, the function component comprises a first function component, the first function component is configured to implement generation of a corresponding image work based on a text and an image generation model, and the displaying a second information display interface of the sharing platform in response to an interaction operation for a target object in a target region comprises:
determining first guidance information in response to an input operation for a first information input control of the first function component in the first display region, wherein the first guidance information comprises text information corresponding to the input operation; and
displaying the second information display interface of the sharing platform in response to a first generation instruction, wherein the second information display interface is configured to display an image work correspondingly generated based on the first guidance information and a first image generation model.

3. The method according to claim 2, wherein the displaying a second information display interface of the sharing platform in response to an interaction operation for a target object in a target region comprises:
displaying a first intermediate information display interface of the sharing platform in response to a second generation instruction for a creation control of the first function component in the first display region, wherein the first intermediate information display interface comprises a configuration item of a plurality of image attributes and a second information input control;
determining second guidance information in response to an input operation for the second information input control and a configuration operation for the configuration item, wherein the second guidance information comprises text information corresponding to the input operation and attribute configuration information corresponding to the configuration operation; and
displaying the second information display interface of the sharing platform in response to a third generation instruction, wherein the second information display interface is configured to display an image work correspondingly generated based on the second guidance information and a second image generation model.

4. The method according to claim 1, wherein the function component comprises a second function component, the second function component is configured to implement generation of a corresponding image work based on a text, an image, and an image generation model, and the displaying a second information display interface of the sharing platform in response to an interaction operation for a target object in a target region comprises:
determining third guidance information in response to an input operation for a third information input control of the second function component in the first display region, wherein the third guidance information comprises text information and image information corresponding to the input operation; and
displaying the second information display interface of the sharing platform in response to a fourth generation instruction, wherein the second information display interface is configured to display an image work correspondingly generated based on the third guidance information and a third image generation model.

5. The method according to claim 4, wherein the displaying a second information display interface of the sharing platform in response to an interaction operation for a target object in a target region comprises:
displaying a second intermediate information display interface of the sharing platform in response to a fifth generation instruction for a creation control of the second function component in the second display region, wherein the second intermediate information display interface comprises a configuration item of a plurality of image attributes and a fourth information input control;
determining fourth guidance information in response to an input operation for the fourth information input control and a configuration operation for the configuration item, wherein the fourth guidance information comprises text information and image information corresponding to the input operation, and attribute configuration information corresponding to the configuration operation; and
displaying the second information display interface of the sharing platform in response to a sixth generation instruction, wherein the second information display interface is configured to display an image work correspondingly generated based on the fourth guidance information and a fourth image generation model.

6. The method according to claim 1, wherein the target region comprises the second display region, the target object comprises an image work displayed in the second display region, and the displaying a second information display interface of the sharing platform in response to an interaction operation for a target object in a target region comprises:
displaying the second information display interface of the sharing platform in response to a selection operation for an image work displayed in the second display region, wherein the second information display interface displays a first interaction control for the image work, and the first interaction control comprises a collection control for a user to collect an image work and/or a copy control for a user to copy an image work.

7. The method according to claim 1, wherein the first information display interface further comprises a third display region, the third display region is configured to display a second interaction control related to a user, and the second interaction control comprises a collection control for entering an interface that displays an image work collected by the user and a user work control for entering an interface that displays an image work created by the user.

8. A non-transitory computer-readable medium having a computer program stored thereon, wherein when the program is executed by a processing apparatus, steps of an information display method, the method comprises:
displaying a first information display interface of a sharing platform, wherein the first information display interface comprises a first display region and a second display region, the first display region is configured to display a function component that provides a function of drawing an image work, and the second display region is configured to display image works drawn by different users based on the sharing platform; and
displaying a second information display interface of the sharing platform in response to an interaction operation for a target object in a target region, wherein the target region is the first display region or the second display region, and the target object is the function component or an image work displayed in the second display region.

9. An electronic device, comprising:
a storage apparatus having a computer program stored thereon; and
a processing apparatus configured to execute the computer program in the storage apparatus to:
display a first information display interface of a sharing platform, wherein the first information display interface comprises a first display region and a second display region, the first display region is configured to display a function component that provides a function of drawing an image work, and the second display region is configured to display image works drawn by different users based on the sharing platform; and
display a second information display interface of the sharing platform in response to an interaction operation for a target object in a target region, wherein the target region is the first display region or the second display region, and the target object is the function component or an image work displayed in the second display region.

10. The electronic device according to claim 9, wherein the target region comprises the first display region, the target object comprises the function component, the function component comprises a first function component, the first function component is configured to implement generation of a corresponding image work based on a text and an image generation model, and the displaying a second information display interface of the sharing platform in response to an interaction operation for a target object in a target region comprises:
determining first guidance information in response to an input operation for a first information input control of the first function component in the first display region, wherein the first guidance information comprises text information corresponding to the input operation; and
displaying the second information display interface of the sharing platform in response to a first generation instruction, wherein the second information display interface is configured to display an image work correspondingly generated based on the first guidance information and a first image generation model.

11. The electronic device according to claim 10, wherein the displaying a second information display interface of the sharing platform in response to an interaction operation for a target object in a target region comprises:
displaying a first intermediate information display interface of the sharing platform in response to a second generation instruction for a creation control of the first function component in the first display region, wherein the first intermediate information display interface comprises a configuration item of a plurality of image attributes and a second information input control;
determining second guidance information in response to an input operation for the second information input control and a configuration operation for the configuration item, wherein the second guidance information comprises text information corresponding to the input operation and attribute configuration information corresponding to the configuration operation; and
displaying the second information display interface of the sharing platform in response to a third generation instruction, wherein the second information display interface is configured to display an image work correspondingly generated based on the second guidance information and a second image generation model.

12. The method according to claim 9, wherein the function component comprises a second function component, the second function component is configured to implement generation of a corresponding image work based on a text, an image, and an image generation model, and the displaying a second information display interface of the sharing platform in response to an interaction operation for a target object in a target region comprises:
determining third guidance information in response to an input operation for a third information input control of the second function component in the first display region, wherein the third guidance information comprises text information and image information corresponding to the input operation; and
displaying the second information display interface of the sharing platform in response to a fourth generation instruction, wherein the second information display interface is configured to display an image work correspondingly generated based on the third guidance information and a third image generation model.

13. The method according to claim 12, wherein the displaying a second information display interface of the sharing platform in response to an interaction operation for a target object in a target region comprises:
displaying a second intermediate information display interface of the sharing platform in response to a fifth generation instruction for a creation control of the second function component in the second display region, wherein the second intermediate information display interface comprises a configuration item of a plurality of image attributes and a fourth information input control;
determining fourth guidance information in response to an input operation for the fourth information input control and a configuration operation for the configuration item, wherein the fourth guidance information comprises text information and image information corresponding to the input operation, and attribute configuration information corresponding to the configuration operation; and
displaying the second information display interface of the sharing platform in response to a sixth generation instruction, wherein the second information display interface is configured to display an image work correspondingly generated based on the fourth guidance information and a fourth image generation model.

14. The method according to claim 9, wherein the target region comprises the second display region, the target object comprises an image work displayed in the second display region, and the displaying a second information display interface of the sharing platform in response to an interaction operation for a target object in a target region comprises:
displaying the second information display interface of the sharing platform in response to a selection operation for an image work displayed in the second display region, wherein the second information display interface displays a first interaction control for the image work, and the first interaction control comprises a collection control for a user to collect an image work and/or a copy control for a user to copy an image work.

15. The method according to claim 9, wherein the first information display interface further comprises a third display region, the third display region is configured to display a second interaction control related to a user, and the second interaction control comprises a collection control for entering an interface that displays an image work collected by the user and a user work control for entering an interface that displays an image work created by the user.
